(19) United States
(12) Patent Application Publication
(10) Pub. No.: US 2022/0262111 A1
(43) Pub. Date: Aug. 18, 2022

(54) ROAD SURFACE INSPECTION APPARATUS, ROAD SURFACE INSPECTION METHOD, AND PROGRAM

(71) Applicant: NEC Corporation, Minato-Ku, Tokyo (JP)

(72) Inventors: Kenichi YAMASAKI, Tokyo (JP); Gaku NAKANO, Tokyo (JP); Shinichiro SUMI, Tokyo (JP)

(73) Assignee: NEC Corporation, Minato-Ku, Tokyo (JP)

(21) Appl. No.: 17/620,564

(22) PCT Filed: Jun. 28, 2019
(86) PCT No.: PCT/JP2019/025949

§ 371 Date: Dec. 17, 2021

(51) Int. Cl. G06V 20/10; G06T 7/00; G06V 10/26; G06V 10/25

(52) U.S. Cl. CPC G06V 20/182; G06T 7/0004; G06V 10/26; G06T 2207/30236; G06T 2207/30132; G06T 2207/30184; G06V 10/25

(57) ABSTRACT

A road surface inspection apparatus (10) includes an image acquisition unit (110), a damage detection unit (120), and an information output unit (130). The image acquisition unit (110) acquires an image in which a road is captured. The damage detection unit (120) sets a target region in the image in image processing for detecting damage to a road, based on an attribute of the road captured in the image, and performs the image processing on the set target region. The information output unit (130) outputs position determination information allowing determination of a position of a road damage to which is detected by the image processing.

### TECHNICAL FIELD

The present invention relates to a technology for supporting administration work of constructed road surfaces.

### BACKGROUND ART

A road degrades by vehicle traffic, a lapse of time, and the like. Consequently, damage to the surface of the road may occur. Leaving damage to a road untouched may cause an accident. Therefore, a road needs to be periodically checked.

PTL 1 below discloses an example of a technology for efficiently checking a road. PTL 1 below discloses an example of a technology for detecting damage to the surface of a road (such as a crack or a rut) by using an image of the road.

### CITATION LIST

### Patent Literature

PTL 1: Japanese Patent Application Publication No. 2018-021375

### SUMMARY OF INVENTION

### Technical Problem

A load applied by image processing on a computer is generally high. When checking is performed by using an image of a road as is the case with the technology disclosed in PTL 1, a computer processes a massive number of road images. Consequently, processing time in the computer becomes longer, and work efficiency may decline. In order to improve work efficiency, a technology for accelerating processing in a computer is desired.

The present invention has been made in view of the problem described above. An object of the present invention is to provide a technology for improving image processing speed of a computer when a road is checked by using an image of the road.

### Solution to Problem

A road surface inspection apparatus according to the present invention includes:

an image acquisition unit that acquires an image in which a road is captured;

a damage detection unit that sets a target region in the image in image processing for detecting damage to a road, based on an attribute of the road captured in the image, and performs the image processing on the set target region; and

an information output unit that outputs position determination information allowing determination of a position of a road damage to which is detected by the image processing.

A road surface inspection method according to the present invention includes, by a computer:

acquiring an image in which a road is captured;

setting a target region in the image in image processing for detecting damage to a road, based on an attribute of the road captured in the image;

performing the image processing on the set target region; and

outputting position determination information allowing determination of a position of a road damage to which is detected by the image processing.

A program according to the present invention causes a computer to execute the aforementioned road surface inspection method.

### Advantageous Effects of Invention

The present invention provides a technology for improving an image processing speed of a computer when a road is checked by using an image of the road.

### BRIEF DESCRIPTION OF DRAWINGS

The aforementioned object, other objects, features and advantages will become more apparent by use of the following preferred example embodiments and accompanying drawings.

FIG. 1 is a diagram illustrating a functional configuration of a road surface inspection apparatus according to a first example embodiment.

FIG. 2 is a block diagram illustrating a hardware configuration of the road surface inspection apparatus.

FIG. 3 is a flowchart illustrating a flow of processing executed by the road surface inspection apparatus according to the first example embodiment.

FIG. 4 is a diagram illustrating setting rule information defining a rule for setting a target region.

FIG. 5 is a diagram illustrating a functional configuration of a road surface inspection apparatus according to a second example embodiment.

FIG. 6 is a flowchart illustrating a flow of processing executed by the road surface inspection apparatus according to the second example embodiment.

FIG. 7 is a diagram illustrating a functional configuration of a road surface inspection apparatus according to a third example embodiment.

FIG. 8 is a flowchart illustrating a flow of processing executed by the road surface inspection apparatus according to the third example embodiment.

FIG. 9 is a diagram illustrating a functional configuration of a road surface inspection apparatus according to a fourth example embodiment.

FIG. 10 is a diagram illustrating an example of a superimposed image displayed by a display processing unit according to the fourth example embodiment.

FIG. 11 is a diagram illustrating an example of a superimposed image displayed by the display processing unit according to the fourth example embodiment.

FIG. 12 is a diagram illustrating an example of a superimposed image displayed by the display processing unit according to the fourth example embodiment.

FIG. 13 is a diagram illustrating an example of a superimposed image displayed by the display processing unit according to the fourth example embodiment.

FIG. 14 is a diagram illustrating an example of a superimposed image displayed by the display processing unit according to the fourth example embodiment.

FIG. 15 is a diagram illustrating a functional configuration of a road surface inspection apparatus according to a fifth example embodiment.

FIG. 16 is a flowchart illustrating a flow of processing executed by the road surface inspection apparatus according to the fifth example embodiment.

FIG. 17 is a diagram illustrating another example of setting rule information defining a rule for setting a target region.

### EXAMPLE EMBODIMENTS

Example embodiments of the present invention will be described below by using drawings. Note that, in every drawing, similar components are given similar signs, and description thereof is not repeated as appropriate. Further, each block in each block diagram represents a function-based configuration rather than a hardware-based configuration unless otherwise described. Further, a direction of an arrow in a diagram is for facilitating understanding of an information flow and does not limit a direction of communication (unidirectional communication/bidirectional communication) unless otherwise described.

### First Example Embodiment

### Functional Configuration Example

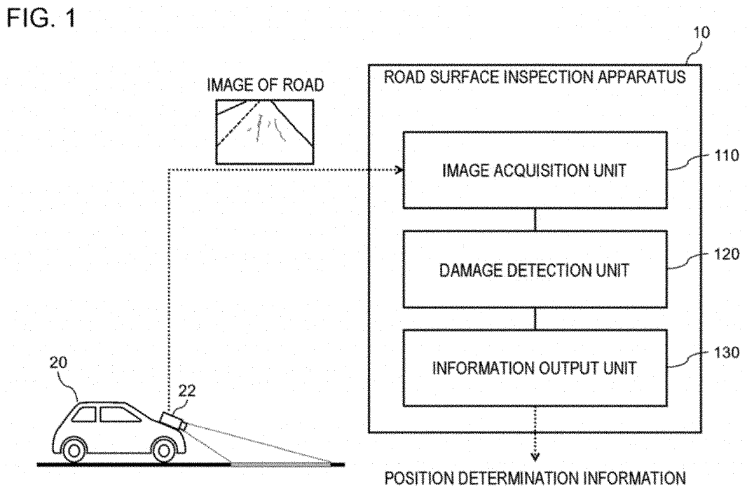

FIG. 1 is a diagram illustrating a functional configuration of a road surface inspection apparatus 10 according to a first example embodiment. As illustrated in FIG. 1, the road surface inspection apparatus 10 according to the present example embodiment includes an image acquisition unit 110, a damage detection unit 120, and an information output unit 130.

The image acquisition unit 110 acquires an image in which a road surface being a checking target is captured. As illustrated in FIG. 1, an image of a road surface is generated by an image capture apparatus 22 equipped on a vehicle 20. Specifically, a road surface video of a road in a checking target section is generated by the image capture apparatus 22 performing an image capture operation while the vehicle 20 travels on the road in the checking target section. The image acquisition unit 110 acquires at least one of a plurality of frame images constituting the road surface video as an image being a target of image processing (analysis). When the image capture apparatus 22 has a function of connecting to a network such as the Internet, the image acquisition unit 110 may acquire an image of a road surface from the image capture apparatus 22 through the network. Further, the image capture apparatus 22 having the network connection function may be configured to transmit a road surface video to a video database, which is unillustrated, and the image acquisition unit 110 may be configured to acquire the road surface video by accessing the video database. Further, for example, the image acquisition unit 110 may acquire a road surface video from the image capture apparatus 22 connected by a communication cable or a portable storage medium such as a memory card.

With respect to an image of a road surface acquired by the image acquisition unit 110, the damage detection unit 120 sets a region being a target of image processing for detecting damage to a road (hereinafter denoted as a “target region”), based on an attribute of the road captured in the image. Then, the damage detection unit 120 performs image processing for detecting damage to a road on the set target region. Examples of damage to a road detected by image processing include a crack, a rut, a pothole, a subsidence, a dip, and a step that are caused on the road surface.

When damage to a road is detected by the damage detection unit 120, the information output unit 130 generates and outputs information allowing determination of a position where the damage is detected (hereinafter also denoted as “position determination information”). Note that the information output unit 130 may use information indicating the image capture position (latitude and longitude) of an image being a processing target (that is, information indicating the latitude and longitude of a road), the position being included in metadata (such as Exchangeable Image File Format (Exif)) of the image, as position determination information. Further, when the image acquisition unit 110 acquires position data along with an image, the information output unit 130 may use the position data acquired with the image as position determination information. Further, the position of a road captured in a processing target image may be estimated from a frame number of video data. For example, when a video including 36,000 frames is acquired as a result of traveling in a certain section, the 18,000-th frame may be estimated to be in the neighborhood of the midway point of the section. Further, when control data of the vehicle 20 during traveling are acquired, the image capture position of a frame image (a road position) can be estimated with higher precision by further using the control data. Accordingly, the information output unit 130 may use a frame number of a processing target image as position determination information. In this case, the information output unit 130 generates and outputs position determination information including at least one item out of latitude-longitude information of the road and a frame number in the video data. Further, the damage detection unit 120 may be configured to further recognize a specific object (such as a kilo-post or a sign indicating an address or a road name) allowing determination of an image capture position in image processing, and the information output unit 130 may be configured to use information acquired from the recognition result of the specific object (such as a number on the kilo-post, or an address or a road name described on the sign) as position determination information.

### Hardware Configuration Example

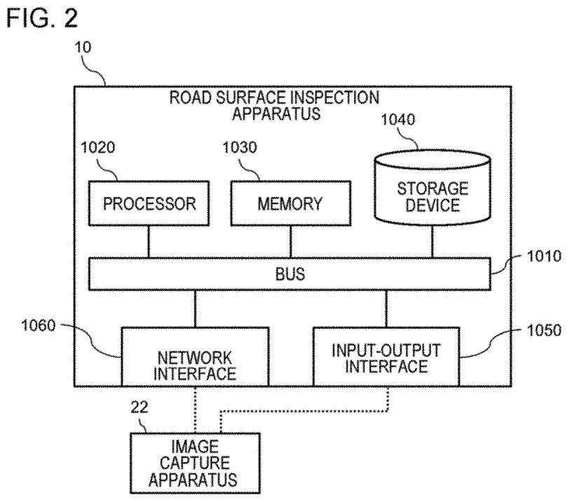

Each functional component in the road surface inspection apparatus 10 may be provided by hardware (such as a hardwired electronic circuit) providing the functional component or may be provided by a combination of hardware and software (such as a combination of an electronic circuit and a program controlling the circuit). The case of providing each functional component in the road surface inspection apparatus 10 by a combination of hardware and software will be further described by using FIG. 2. FIG. 2 is a block diagram illustrating a hardware configuration of the road surface inspection apparatus 10.

The road surface inspection apparatus 10 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from one another. Note that a method for interconnecting the processor 1020 and other components is not limited to a bus connection.

The processor 1020 is a processor configured with a central processing unit (CPU), a graphics processing unit (GPU), or the like.

The memory 1030 is a main storage configured with a random access memory (RAM) or the like.

The storage device 1040 is an auxiliary storage configured with a hard disk drive (HDD), a solid state drive (SSD), a memory card, a read only memory (ROM), or the like. The storage device 1040 stores a program module implementing each function of the road surface inspection apparatus 10 (such as the image acquisition unit 110, the damage detection unit 120, or the information output unit 130). By the processor 1020 reading each program module into the memory 1030 and executing the program module, each function related to the program module is provided.

The input-output interface 1050 is an interface for connecting the road surface inspection apparatus 10 to various input-output devices. The input-output interface 1050 may be connected to input apparatuses (unillustrated) such as a keyboard and a mouse, output apparatuses (unillustrated) such as a display and a printer, and the like. Further, the input-output interface 1050 may be connected to the image capture apparatus 22 (or a portable storage medium equipped on the image capture apparatus 22). The road surface inspection apparatus 10 can acquire a road surface video generated by the image capture apparatus 22 by communicating with the image capture apparatus 22 (or the portable storage medium equipped on the image capture apparatus 22) through the input-output interface 1050.

The network interface 1060 is an interface for connecting the road surface inspection apparatus 10 to a network. Examples of the network include a local area network (LAN) and a wide area network (WAN). The method for connecting the network interface 1060 to the network may be a wireless connection or a wired connection. The road surface inspection apparatus 10 can acquire a road surface video generated by the image capture apparatus 22 by communicating with the image capture apparatus 22 or a video database, which is unillustrated, through the network interface 1060.

Note that the hardware configuration of the road surface inspection apparatus 10 is not limited to the configuration illustrated in FIG. 2.

### <Flow of Processing>

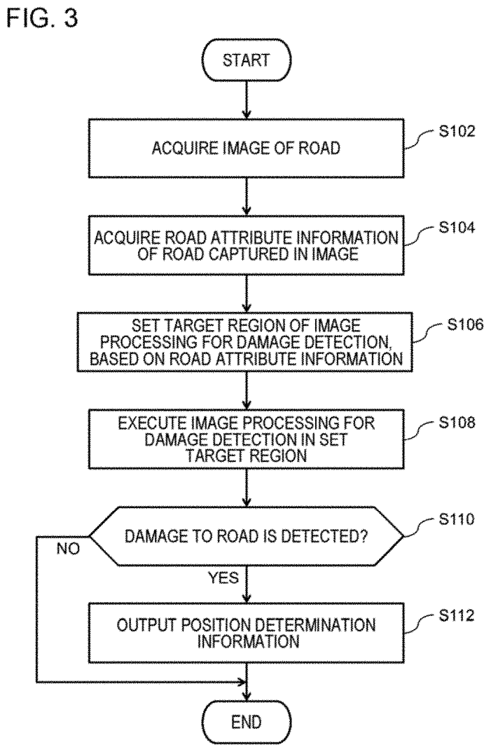

FIG. 3 is a flowchart illustrating a flow of processing executed by the road surface inspection apparatus 10 according to the first example embodiment.

First, the image acquisition unit 110 acquires an image of a road to be a processing target (S102). For example, the image acquisition unit 110 acquires a road surface video generated by the image capture apparatus 22 through the input-output interface 1050 or the network interface 1060. Then, the image acquisition unit 110 reads a plurality of frame images constituting the road surface video in whole or in part as images of the processing target road. The image acquisition unit 110 may be configured to execute preprocessing on the road image in order to improve processing efficiency in a downstream step. For example, the image acquisition unit 110 may execute preprocessing such as front correction processing or deblurring processing on the road image.

Next, the damage detection unit 120 acquires information indicating an attribute of the road captured in the processing target image (road attribute information) acquired from the image acquisition unit 110 (S104). For example, an attribute of a road includes at least one item out of position information of the road (such as Global Positioning System (GPS) information), the construction environment (such as a mountainous region or a flatland) of the road, the type of the road surface (the paving material type such as concrete, asphalt, gravel, brick, or stone pavement), the time elapsed since construction of the road, a vehicle traffic volume at the position of the road, and a past damage history at the position of the road. Several specific examples of a method for acquiring an attribute of a road will be described below. Note that the method for acquiring an attribute of a road is not limited to the examples described below.

For example, the damage detection unit 120 may acquire information indicating the image capture position of a processing target image (the position of a road captured in the image) from Exif data or the like of the image as road attribute information. Further, when position information (information indicating the image capture position of the image) such as GPS information is tied to an image acquired by the image acquisition unit 110, the damage detection unit 120 may acquire the position information as road attribute information of the road captured in a processing target image. Further, when a database (unillustrated) storing information indicating attributes of a road such as the construction environment of the road, the type of the road surface, the date and time of construction of the road, a vehicle traffic volume, and a past damage history in association with the position information of the road is built, the damage detection unit 120 may acquire information indicating at least one of the attributes as described above by referring to the database, based on the position information of a road captured in a processing target image.

Further, the damage detection unit 120 may be configured to determine an attribute of a road, based on an image. For example, the damage detection unit 120 may be configured to determine attributes (such as the construction environment and the type of road surface) of a road captured in an input image by using a discriminator built by a rule base or machine learning. For example, a discriminator that can determine the construction environment of a road captured in an unknown input image (an image of the road) and the type of road surface of the road can be built by preparing a plurality of pieces of learning data combining an image of a road with labels (correct answer labels) indicating the environment of the construction place of the road and the type of road surface and repeating machine learning by using the plurality of pieces of learning data.

Next, the damage detection unit 120 sets a target region of image processing for damage detection, based on the acquired road attribute information (S106).

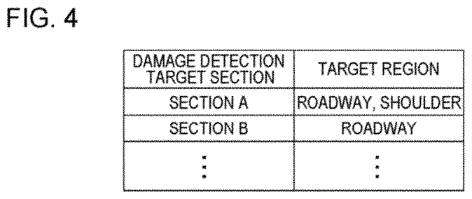

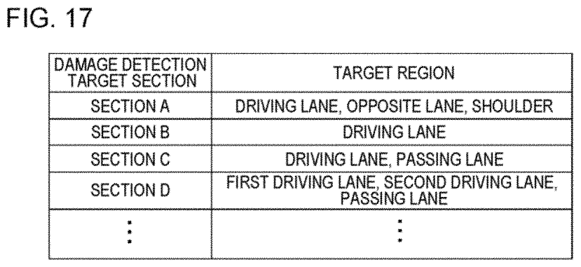

As an example, when acquiring road attribute information indicating position information of a road, the damage detection unit 120 may set a target region of image processing for damage detection according to the position information of the road by, for example, referring to a setting rule of a target region as illustrated in FIG. 4. FIG. 4 is a diagram illustrating setting rule information defining a rule for setting a target region. The setting rule information illustrated in FIG. 4 defines a segment of a road being a target region of image processing for damage detection, the segment being tied to information about a section (position of the road). The setting rule information illustrated in FIG. 4 defines segments of roads being target regions of image processing for damage detection to be a “roadway” and a “shoulder” in a section A, and only the “roadway” in a section B. Note that, for example, the setting rule information as illustrated in FIG. 4 is previously input by a road administrator or a checking company undertaking checking work and is stored in a storage region (such as the memory 1030 or the storage device 1040) in the road surface inspection apparatus 10. For example, when the position information of a road acquired as road attribute information indicates a position included in the section A, the damage detection unit 120 determines road segments of the “roadway” and the “shoulder,” based on the setting rule information illustrated in FIG. 4, and sets pixel regions corresponding to the “roadway” and the “shoulder” to a target region of image processing for damage detection. Further, when the position information of a road acquired as road attribute information indicates a position included in the section B, the damage detection unit 120 determines a road segment of the “roadway,” based on the setting rule information illustrated in FIG. 4, and sets a pixel region corresponding to the “roadway” to a target region of image processing for damage detection. Note that a setting rule subdividing a roadway segment on a per lane basis may be provided as illustrated in FIG. 17. FIG. 17 is a diagram illustrating another example of setting rule information defining a rule for setting a target region. For example, when the position information of a road acquired as road attribute information indicates a position included in a section A, the damage detection unit 120 determines road segments of a “driving lane,” an “opposite lane,” and a “shoulder,” based on the setting rule information illustrated in FIG. 17. Then, the damage detection unit 120 sets pixel regions corresponding to the “driving lane,” the “opposite lane,” and the “shoulder” to a target region of image processing for damage detection. Further, when the position information of a road acquired as road attribute information indicates a position included in a section B, the damage detection unit 120 determines a road segment of the “driving lane,” based on the setting rule information illustrated in FIG. 17. Then, the damage detection unit 120 sets a pixel region corresponding to the “driving lane” to a target region of image processing for damage detection. Further, when the position information of a road acquired as road attribute information indicates a position included in a section C, the damage detection unit 120 determines road segments of the “driving lane” and a “passing lane,” based on the setting rule information illustrated in FIG. 17. Then, the damage detection unit 120 sets pixel regions corresponding to the “driving lane” and the “passing lane” to a target region of image processing for damage detection. Further, when the position information of a road acquired as road attribute information indicates a position included in a section D, the damage detection unit 120 determines road segments of a “first driving lane,” a “second driving lane,” and the “passing lane,” based on the setting rule information illustrated in FIG. 17. Then, the damage detection unit 120 sets pixel regions corresponding to the “first driving lane,” the “second driving lane,” and the “passing lane” to a target region of image processing for damage detection. Note that, for example, the damage detection unit 120 may determine pixel regions corresponding to segments such as the “opposite lane,” the “driving lane (first driving lane/second driving lane),” the “passing lane,” and the “shoulder,” based on the detection positions of marks such as a roadway center line, a lane borderline, and a roadway outside line.

As another example, when acquiring road attribute information indicating the construction environment of a road, the damage detection unit 120 may set a target region according to the construction environment indicated by the road attribute information. Specific examples include a road with a high traffic volume and a section including a road the side of which or a region outside which (such as a ground region adjoining the shoulder or the road) is severely damaged and deteriorated due to rainfall or the like. Accordingly, when acquiring road attribute information indicating that the construction environment of a road is such a section, for example, the damage detection unit 120 sets a region including a region outside the roadway outside line to a target region of image processing for damage detection. Further, when acquiring road attribute information indicating that the construction environment of a road is a section in which only a roadway is assumed as a damage detection target, for example, the damage detection unit 120 sets a region inside the roadway outside line to a target region of image processing for damage detection.

As another example, when acquiring road attribute information indicating a type of road surface, the damage detection unit 120 may set a target region of image processing for damage detection, based on the road surface type indicated by the road attribute information and a determination criterion provided by a road administrator or a checking company. For example, a road administrator or a checking company may perform checking with a predetermined type of road surface only as a target. As a specific example, a case that a road administrator or a checking company assumes only a road surface paved by asphalt or concrete as a checking target and does not assume a road surface paved by other materials such as gravel (gravel road) as a checking target may be considered. In this case, the damage detection unit 120 sets a road as a target region when the road surface type indicated by road attribute information is asphalt pavement or concrete pavement and does not set the road as a target region (does not assume the road as a detection target) when the road surface type is another type such as gravel (gravel road).

As another example, when acquiring road attribute information indicating a traffic volume of a road, the damage detection unit 120 may set a target region of image processing for damage detection according to the traffic volume indicated by the road attribute information. For example, the damage detection unit 120 may set a roadway and a shoulder to a target region for a section with a high traffic volume (the traffic volume exceeding a predetermined threshold value) and may set only a roadway to a target region of image processing for damage detection for a section with a low traffic volume (the traffic volume being equal to or less than the predetermined threshold value).

As another example, when acquiring road attribute information indicating a past damage history, the damage detection unit 120 may determine a target region of image processing for damage detection, based on the past damage history. As a specific example, it is assumed that information indicating that damage has occurred in the past in both roadway and shoulder regions with a roadway outside line as a boundary is acquired as road attribute information of a road captured in a processing target image. In this case, the damage detection unit 120 sets a target region of image processing for damage detection in such a way that both a region inside the roadway outside line (a roadway region) and a region outside the roadway outside line (such as a shoulder and a roadside ground region) are included.

For example, the damage detection unit 120 may determine a region corresponding to a road segment such as the “roadway” or the “shoulder” out of an image as follows. First, the damage detection unit 120 detects a predetermined mark (such a demarcation line, a road surface mark, a curb, or a guardrail) for determining a road region out of a processing target image. In this case, for example, the damage detection unit 120 may use an algorithm for detecting a mark on a road, the algorithm being known in the field of self-driving technology or the like. Then, the damage detection unit 120 determines a region corresponding to the road, based on the detection position of the predetermined mark. Note that there may be a case that a predetermined mark such as a roadway outside line cannot be detected in a processing target image. In this case, for example, the damage detection unit 120 may be configured to determine a road region and a ground region outside the road based on a color feature value or the like extractable from an image. The damage detection unit 120 may be configured to determine a road region by using a discriminator being built to allow identification of a border between a road region and a ground region outside the road by machine learning. After a road region is determined, the damage detection unit 120 segments the road region into a plurality of regions (such as a roadway region, a shoulder region, and a sidewalk region) in a widthwise direction. Then, by using the result of segmenting the road captured in the image into a plurality of regions (such as a roadway, a shoulder and a sidewalk) in a widthwise direction of the road, the damage detection unit 120 sets a target region of image processing for damage detection. By thus detecting a pixel region corresponding to a road out of an image and setting a target region of image processing in the region, the possibility of erroneously detecting damage to the road by a feature value extractable from a region other than the road (such as a surrounding background region) is reduced. Thus, precision in detection of damage to a road (precision in image processing) improves.

Next, the damage detection unit 120 executes image processing for damage detection on the set target region (S108). As a result of the image processing, existence of damage to the road captured in the processing target image is determined.

Then, when damage to the road is detected by the image processing (S110: YES), the information output unit 130 outputs position determination information allowing determination of the position of the damaged road (S112). For example, the information output unit 130 may acquire information indicating the image capture position of an image included in Exif data, a frame number of a processing target image in a road surface video, or the like as position determination information. Then, the information output unit 130 lists position information generated based on an image processing result of each image included in the road surface video in a predetermined format (such as Comma Separated Values (CSV) format). The information output unit 130 outputs the listed position information to a storage region in the memory 1030, the storage device 1040, or the like. Further, the information output unit 130 may be configured to output and display a list of position determination information to and on a display, which is unillustrated.

### <Example of Advantageous Effect>

When existence of damage to a road is checked by using an image, first, a target region of image processing for damage detection is set based on an attribute of a road captured in a processing target image, according to the present example embodiment. Then, image processing for damage detection is executed on the set target region. By thus limiting a target region of image processing, based on road attribute information, the image processing can be accelerated. Note that when existence of damage to a road is checked by using an image, many images generally need to be processed. Therefore, with the configuration as described in the present example embodiment, an effect of accelerating image processing can be more remarkably acquired. Further, position determination information allowing determination of the position where damage to a road is detected by image processing is output, according to the present example embodiment. By referring to the position determination information, a person involved in road checking work can easily recognize the position of the damaged road.

### Second Example Embodiment

A road surface inspection apparatus 10 according to the present example embodiment has a configuration similar to that in the first example embodiment except for a point described below.

### Functional Configuration Example

The type of damage, the likelihood of occurrence of damage, and the like may vary with the position of a road (specifically, the construction environment of the road, the type of road surface, a traffic volume, and the like that are determined based on the position). A damage detection unit 120 according to the present example embodiment is configured to switch a discriminator (processing logic for detecting damage to a road) used in image processing for damage detection, based on an attribute of a road captured in the image.

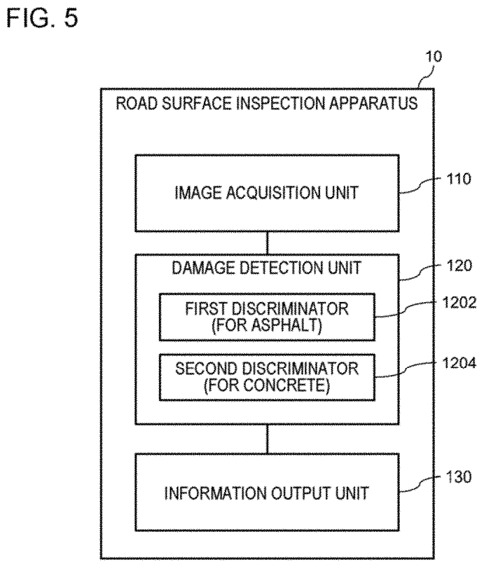

FIG. 5 is a diagram illustrating a functional configuration of the road surface inspection apparatus 10 according to the second example embodiment. In FIG. 5, the road surface inspection apparatus 10 includes a discriminator (processing logic) for each type of road surface, and the damage detection unit 120 is configured to switch a discriminator used in image processing according to the type of road surface of a road captured in a processing target image. In the example in FIG. 5, the road surface inspection apparatus 10 includes a first discriminator 1202 built especially for damage to a road surface paved by asphalt and a second discriminator 1204 built especially for damage to a road surface paved by concrete. Note that, while not being illustrated, discriminators dedicated to damage to other types of road surface such as stone pavement and gravel may be further prepared. Further, while not being illustrated, discriminators related to other attributes such as the construction environment of a road and a traffic volume may be further prepared.

### <Flow of Processing>

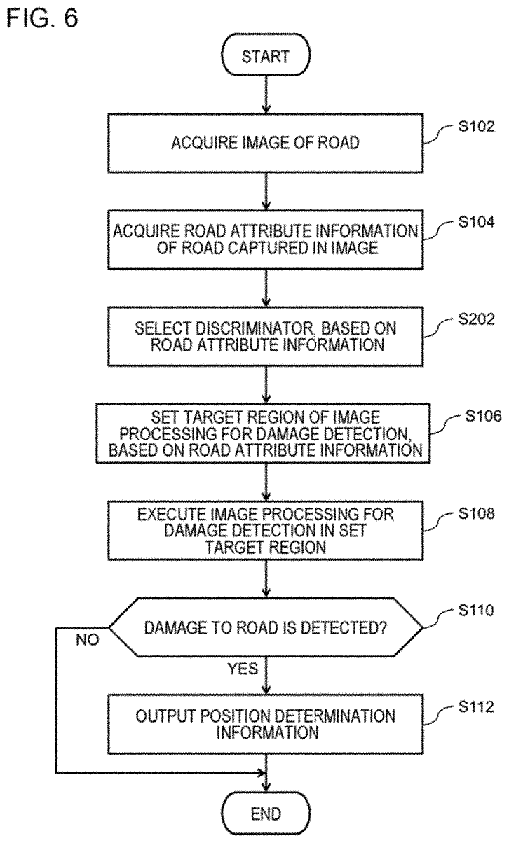

FIG. 6 is a flowchart illustrating a flow of processing executed by the road surface inspection apparatus 10 according to the second example embodiment. The flowchart according to the present example embodiment differs from the flowchart in FIG. 3 in further including a step in S202.

The damage detection unit 120 according to the present example embodiment selects a discriminator (processing logic) used in image processing, based on road attribute information acquired in processing in S104 (S202). For example, when road attribute information indicating that the type of road surface is asphalt is acquired, the damage detection unit 120 selects the first discriminator 1202 as a discriminator used in image processing. Then, in processing in S108, the damage detection unit 120 executes image processing using the discriminator selected in the processing in S202 on a target region set in processing in S106.

### <Example of Advantageous Effect>

As described above, according to the present example embodiment, a plurality of discriminators (processing logic in image processing for damage detection) are prepared according to an attribute of a road, and image processing is executed by using a discriminator related to an attribute of a road captured in a processing target image. By performing image processing for damage detection by using a suitable discriminator (processing logic) according to an attribute of a road, an effect of improving precision in detection of damage to a road is acquired.

### Third Example Embodiment

The present example embodiment has a configuration similar to that in the aforementioned first example embodiment or second example embodiment except for the following point.

### Functional Configuration Example

The type of existing damage to a road is information necessary for determining repair work to be performed later. A damage detection unit 120 according to the present example embodiment is configured to further identify the type of damage detected in image processing. Further, an information output unit 130 according to the present example embodiment is configured to further output information indicating the type of damage to a road detected in image processing in association with position determination information.

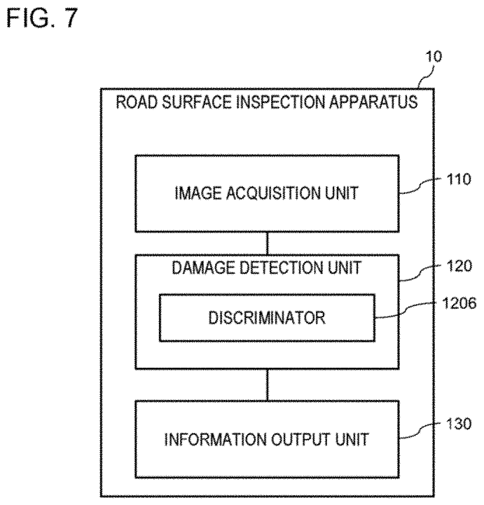

FIG. 7 is a diagram illustrating a functional configuration of a road surface inspection apparatus 10 according to the third example embodiment. In FIG. 7, the damage detection unit 120 includes a discriminator 1206 built to output information indicating the type of damage detected in image processing. For example, the discriminator 1206 is built to be able to identify the type of damage by repeating machine learning by using learning data combining a learning image with a correct answer label indicating the type of damage (such as a crack, a rut, a pothole, a subsidence, a dip, and a step) existing in the image.

### <Flow of Processing>

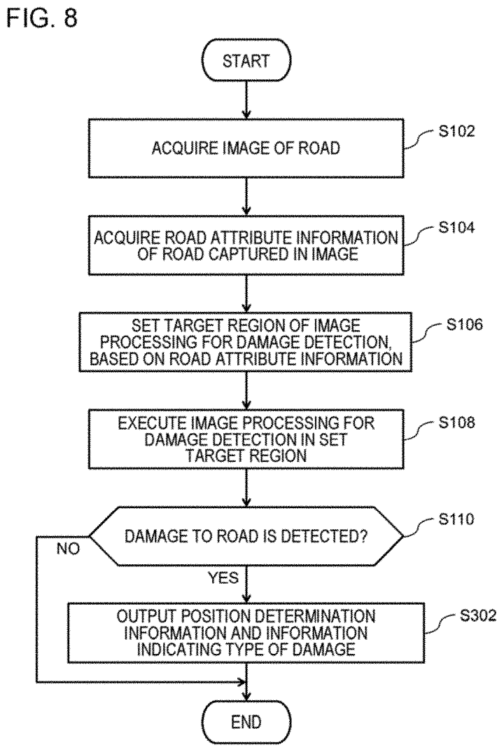

FIG. 8 is a flowchart illustrating a flow of processing executed by the road surface inspection apparatus 10 according to the third example embodiment. A step in S302 in the flowchart according to the present example embodiment is the difference from the flowchart in FIG. 3.

When damage to a road is detected in image processing in S108, the information output unit 130 according to the present example embodiment outputs information including information indicating the type of the detected damage and position determination information (S302). For example, the information output unit 130 outputs CSV-format data including position determination information and information indicating a type of damage (such as code information assigned for each damage type) in one record.

### <Example of Advantageous Effect>

As described above, position determination information allowing determination of the position of a damaged road along with information indicating the type of damage detected at the position are output, according to the present example embodiment. A person involved in road maintenance-checking work can easily recognize a required restoration action and a position where the action is to be taken by checking the position determination information and the information indicating the type of damage to a road.

### Modified Examples

The information output unit 130 according to the present example embodiment may be configured to compute a score (degree of damage) for each type of damage identified in image processing and further output information indicating the score computed for each type of damage. For example, the information output unit 130 may be configured to total areas (numbers of pixels) of image regions in which damage is detected for each type of damage and compute and output the proportion of the total area to the area of the target region of image processing as information indicating a degree of damage. A person involved in road maintenance-checking work can suitably determine a priority order of repair work, based on information indicating the type of damage and the degree of damage.

Further, urgency of repair (risk of damage) may vary with a type or a position of damage. For example, a pothole is more likely to adversely affect traffic of vehicles and people compared with a crack or the like and is considered to be damage with greater urgency of repair. Further, for example, comparing a case of damage existing at the center of a roadway or a sidewalk with a case of damage existing at the side of a roadway or a sidewalk, the former position is considered to be more likely to adversely affect a passing vehicle or person and lead to damage with greater urgency of repair. Then, the information output unit 130 may be configured to perform weighting according to the type or position of detected damage and compute a degree of damage. For example, the information output unit 130 is configured to compute a degree of damage by using a weighting factor predefined for each type of damage or a weighting factor determined according to the detection position of damage. With the configuration, a “degree of damage” output from the information output unit 130 becomes information more accurately representing urgency of repair. In other words, a “degree of damage” output from the information output unit 130 becomes information more useful to a person performing road maintenance-checking work. For example, a person performing road maintenance-checking work can make efficient plans such as preferential implementation of more effective repair work, based on a “degree of damage” output from the information output unit 130.

### Fourth Example Embodiment

The present example embodiment has a configuration similar to that in one of the first example embodiment, the second example embodiment, and the third example embodiment except for a point described below.

### <Functional Configuration>

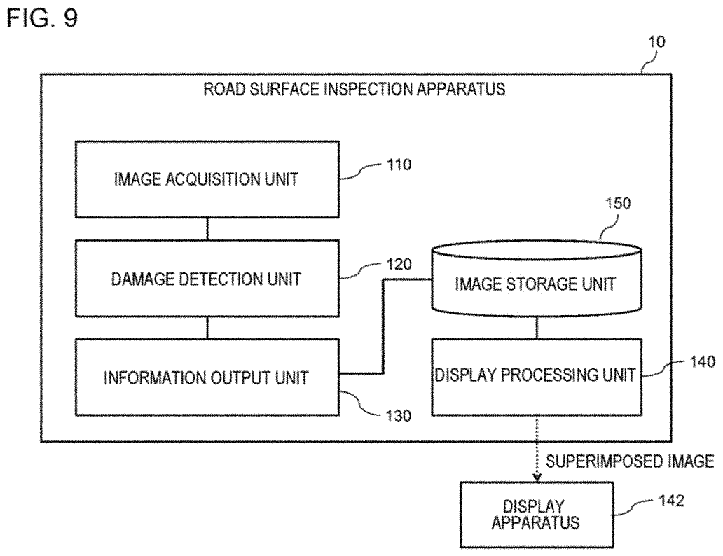

FIG. 9 is a diagram illustrating a functional configuration of a road surface inspection apparatus 10 according to the fourth example embodiment. As illustrated in FIG. 9, the road surface inspection apparatus 10 according to the present example embodiment further includes a display processing unit 140 and an image storage unit 150.

The display processing unit 140 according to the present example embodiment displays a superimposed image on a display apparatus 142 connected to the road surface inspection apparatus 10. A superimposed image is an image acquired by superimposing, on an image of a road, information indicating the position of damage to the road detected by image processing and is, for example, generated by an information output unit 130. As an example, the information output unit 130 determines a region where damage is positioned in an image of a processing target road, based on a result of image processing executed by a damage detection unit 120 and generates superimposition data allowing the position of the region to be distinguishable. Then, by superimposing the superimposition data on the image of the road, the information output unit 130 generates a superimposed image. The information output unit 130 stores the generated superimposed image in the image storage unit 150 (such as a memory 1030 or a storage device 1040) in association with position determination information. For example, when accepting an input specifying position determination information related to an image to be displayed, the display processing unit 140 reads a superimposed image stored in association with the specified position related information from the image storage unit 150 and causes the display apparatus 142 to display the superimposed image.

### <Display Examples of Superimposed Image>

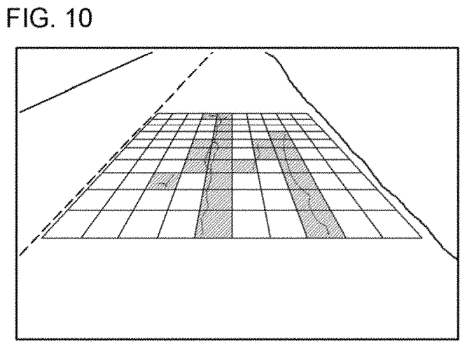

FIG. 10 to FIG. 14 are diagrams illustrating examples of a superimposed image displayed by the display processing unit 140 according to the fourth example embodiment. Note that the diagrams are examples and do not limit the scope of the invention according to the present example embodiment.

A superimposed image illustrated in FIG. 10 includes a display element on a square indicating a target region and a display element highlighting a square corresponding to a position where damage is detected. Such a superimposed image enables recognition of the position of damage at a glance.

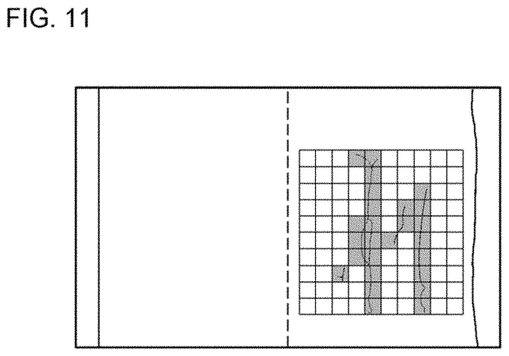

Further, the display processing unit 140 may perform front correction processing during display of a superimposed image. In this case, a superimposed image as illustrated in FIG. 11 in a state that a road is viewed from the top is displayed on the display apparatus 142. The image as illustrated in FIG. 11 enables accurate recognition of the size of damage. Note that the front correction processing may be performed by the information output unit 130 during generation of a superimposed image.

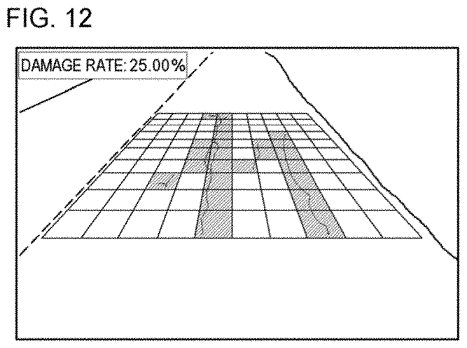

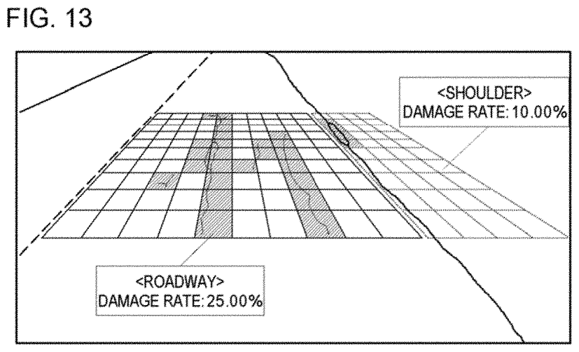

Further, as illustrated in FIG. 12, a superimposed image may include information indicating a degree of damage (a “damage rate” in the example in the diagram). In this case, for example, the information output unit 130 computes a degree of damage, based on the size (the number of squares or the number of pixels) of a target region of image processing and the size of a damaged region, and causes the image storage unit 150 to store the computation result in association with the superimposed image. Then, when displaying a superimposed image, the display processing unit 140 reads information indicating a degree of damage along with the superimposed image and displays the information at a predetermined display position. The information output unit 130 may be configured to compute a degree of damage for each road segment. In this case, for example, the display processing unit 140 displays information indicating a degree of damage for each road segment (such as a “roadway” and a “shoulder”) at a corresponding position, as illustrated in FIG. 13.

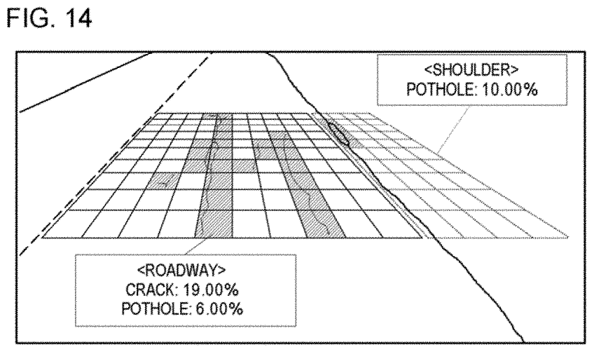

Further, when having a function of computing a score (degree of damage) for each type of damage as described in the third example embodiment, the information output unit 130 may generate a superimposed image including information indicating a score for each type of damage, as illustrated in FIG. 14. Such a superimposed image enables easy recognition of the type and position of damage on a road. For example, a superimposed image illustrated in FIG. 14 enables easy recognition of existence of a crack representing 19% of a roadway region and a pothole representing 6% of the region, and existence of a pothole representing 10% of a shoulder region.

The configuration according to the present example embodiment enables a person performing road maintenance-checking work to easily check a state of damage of a damaged road.

### Fifth Example Embodiment

A road surface inspection apparatus 10 according to the present example embodiment differs from the aforementioned example embodiments in a point described below.

### Functional Configuration Example

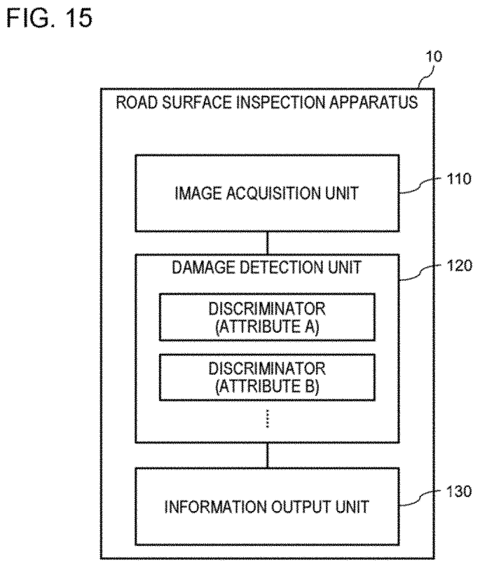

FIG. 15 is a diagram illustrating a functional configuration of the road surface inspection apparatus 10 according to the fifth example embodiment. A damage detection unit 120 according to the present example embodiment includes a plurality of determiners (processing logic of image processing for detecting damage to a road surface). The damage detection unit 120 according to the present example embodiment selects a determiner related to an attribute of a road captured in an image from among the plurality of determiners, based on the attribute. Then, the damage detection unit 120 according to the present example embodiment executes image processing for damage detection by using the selected determiner. On the other hand, the damage detection unit 120 according to the present example embodiment does not have the function of setting a target region of image processing, based on road attribute information, as described in the aforementioned example embodiments.

### Hardware Configuration Example

The hardware configuration is similar to that in FIG. 2. According to the present example embodiment, a storage device 1040 stores a program module for providing the function of the aforementioned damage detection unit 120 in place of a program module for providing the function of the damage detection unit 120. Further, by a processor 1020 reading the program into a memory 1030 and executing the program, the function of the aforementioned damage detection unit 120 is provided.

### <Flow of Processing>

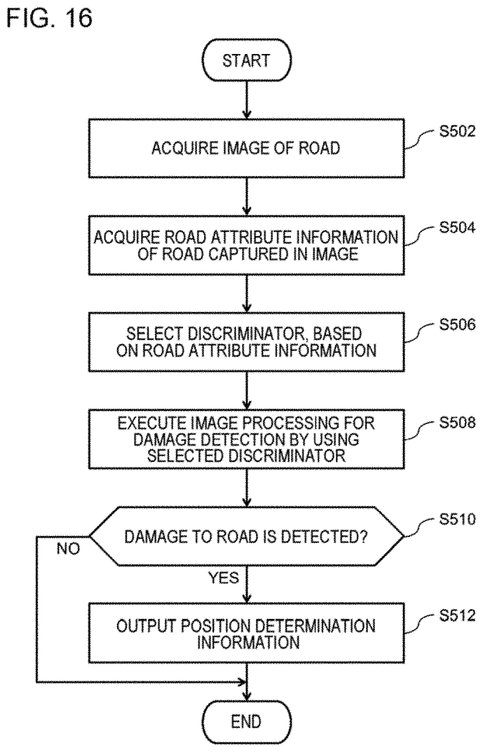

FIG. 16 is a flowchart illustrating a flow of processing executed by the road surface inspection apparatus 10 according to the fifth example embodiment.

First, an image acquisition unit 110 acquires an image of a road to be a processing target (S502). Next, the damage detection unit 120 acquires information indicating an attribute of the road captured in the processing target image (road attribute information) acquired by the image acquisition unit 110 (S504). The processes in S502 and S504 are similar to the processes in S102 and S104 in FIG. 3, respectively.

Next, the damage detection unit 120 selects a discriminator related to road attribute information of the road captured in the processing target image out of a plurality of discriminators prepared for each attribute (S506). For example, when road attribute information indicating a road surface type of “asphalt” is acquired, the damage detection unit 120 selects a discriminator built especially for “asphalt.” Then, the damage detection unit 120 executes image processing for damage detection by using the selected discriminator (S508). As a result of the image processing, existence of damage to the road captured in the processing target image is determined.

When damage is detected by the image processing (S510: YES), the information output unit 130 generates and outputs position determination information allowing determination of the position of the damaged road (S512). The processes in S510 and S512 are similar to the processes in S110 and S112 in FIG. 3, respectively.

### <Example of Advantageous Effect>

As described above, image processing for damage detection is executed by using processing logic related to road attribute information of a road captured in a processing target image, according to the present example embodiment. In other words, image processing for damage detection is executed by using processing logic dedicated to the attribute of the road captured in the image. Such a configuration enables improvement in precision of damage detection by image processing.

While the example embodiments of the present invention have been described with reference to the drawings, the example embodiments shall not limit the interpretation of the present invention, and various changes and modifications may be made based on the knowledge of a person skilled in the art without departing from the spirit of the present invention. A plurality of components disclosed in the example embodiments may form various inventions by appropriate combinations thereof. For example, several components may be deleted from all the components disclosed in the example embodiments, or components in different example embodiments may be combined as appropriate.

Further, while a plurality of steps (processing) are described in a sequential order in each of a plurality of flowcharts used in the aforementioned description, an execution order of steps executed in each example embodiment is not limited to the described order. An order of the illustrated steps may be modified without affecting the contents in each example embodiment. Further, the aforementioned example embodiments may be combined without contradicting one another.

The aforementioned example embodiments may also be described in whole or in part as the following supplementary notes but are not limited thereto.

1. A road surface inspection apparatus including:

an image acquisition unit that acquires an image in which a road is captured;

a damage detection unit that sets a target region in the image in image processing for detecting damage to a road, based on an attribute of the road captured in the image, and performs the image processing on the set target region; and

an information output unit that outputs position determination information allowing determination of a position of a road damage to which is detected by the image processing.

2. The road surface inspection apparatus according to 1., in which

the damage detection unit detects a region corresponding to a road out of the image and sets the target region in the detected region.

3. The road surface inspection apparatus according to 2., in which

the damage detection unit
segments the road captured in the image into a plurality of regions in a widthwise direction of the road and
sets the target region by using a result of segmenting the road into a plurality of regions.
   4. The road surface inspection apparatus according to any one of 1. to 3., in which

the attribute of the road includes at least one item out of position information, a construction environment, a type of road surface, time elapsed since construction of the road, a traffic volume of a vehicle, and a past damage history.

5. The road surface inspection apparatus according to 4., in which

the attribute of the road is position information of the road, and

the damage detection unit sets the target region, based on a rule for region setting previously tied to position information of the road.

6. The road surface inspection apparatus according to any one of 1. to 5., in which

the damage detection unit determines the attribute of the road, based on the image.

7. The road surface inspection apparatus according to any one of 1. to 6., in which

the damage detection unit switches processing logic used in the image processing, based on an attribute of the road.

8. The road surface inspection apparatus according to 7., in which

the attribute of the road is a type of road surface of the road, and

the damage detection unit determines processing logic used in the image processing, based on the type of road surface.

9. The road surface inspection apparatus according to any one of 1. to 8., in which

the damage detection unit further identifies a type of damage to the road in the image processing, and

the information output unit further outputs information indicating the type of damage to the road detected by the image processing.

10. The road surface inspection apparatus according to 9., in which

the information output unit computes a degree of damage for each identified type of damage to the road and further outputs information indicating the degree of damage computed for the each type of damage.

11. The road surface inspection apparatus according to any one of 1. to 10., in which

the position determination information includes at least one item out of latitude-longitude information of the road and a frame number of the image.

12. The road surface inspection apparatus according to any one of 1. to 11., further including

a display processing unit that displays, on a display apparatus, a superimposed image acquired by superimposing, on the image, information indicating a position of damage to the road detected by the image processing.

13. A road surface inspection method including, by a computer:

acquiring an image in which a road is captured;

setting a target region in the image in image processing for detecting damage to a road, based on an attribute of the road captured in the image;

performing the image processing on the set target region; and

outputting position determination information allowing determination of a position of a road damage to which is detected by the image processing.

14. The road surface inspection method according to 13., further including, by the computer,

detecting a region corresponding to a road out of the image and setting the target region in the detected region.

15. The road surface inspection method according to 14., further including, by the computer:
segmenting the road captured in the image into a plurality of regions in a widthwise direction of the road; and
setting the target region by using a result of segmenting the road into a plurality of regions.
   16. The road surface inspection method according to any one of 13. to 15., in which

the attribute of the road includes at least one item out of position information, a construction environment, a type of road surface, time elapsed since construction of the road, a traffic volume of a vehicle, and a past damage history.

17. The road surface inspection method according to 16., in which

the attribute of the road is position information of the road, and

the road surface inspection method further includes, by the computer,
setting the target region, based on a rule for region setting previously tied to position information of the road.
   18. The road surface inspection method according to any one of 13. to 17., further including, by the computer,

determining the attribute of the road, based on the image.

19. The road surface inspection method according to any one of 13. to 18., further including, by the computer,

switching processing logic used in the image processing, based on the attribute of the road.

20. The road surface inspection method according to 19., in which

the attribute of the road is a type of road surface of the road, and

the road surface inspection method further includes, by the computer,
determining processing logic used in the image processing, based on the type of road surface.
   21. The road surface inspection method according to any one of 13. to 20., further including, by the computer:

identifying a type of damage to the road in the image processing; and

further outputting information indicating the type of damage to the road detected by the image processing.

22. The road surface inspection method according to 21., further including, by the computer,

computing a degree of damage for each identified type of damage to the road and further outputting information indicating the degree of damage computed for the each type of damage.

23. The road surface inspection method according to any one of 13. to 22., in which

the position determination information includes at least one item out of latitude-longitude information of the road and a frame number of the image.

24. The road surface inspection method according to any one of 13. to 23., further including, by the computer,

displaying, on a display apparatus, a superimposed image acquired by superimposing, on the image, information indicating a position of damage to the road detected by the image processing.

25. A program causing a computer to execute the road surface inspection method according to any one of 13. to 24.
26. A road surface inspection apparatus including:

an image acquisition unit that acquires an image in which a road is captured;

a damage detection unit that selects processing logic in image processing for detecting damage to a road surface, based on an attribute of the road captured in the image and performs image processing on the image by using the selected processing logic; and

an information output unit that outputs position determination information allowing determination of a position of a road damage to which is detected by the image processing.

What is claimed is:

1. A road surface inspection apparatus comprising:
an image acquisition unit that acquires an image in which a road is captured;
a damage detection unit that sets a target region in the image in image processing for detecting damage to a road, based on an attribute of the road captured in the image, and performs the image processing on the set target region; and
an information output unit that outputs position determination information allowing determination of a position of a road damage to which is detected by the image processing.

2. The road surface inspection apparatus according to claim 1, wherein
the damage detection unit detects a region corresponding to a road out of the image and sets the target region in the detected region.

3. The road surface inspection apparatus according to claim 2, wherein
the damage detection unit
segments the road captured in the image into a plurality of regions in a widthwise direction of the road and
sets the target region by using a result of segmenting the road into a plurality of regions.

4. The road surface inspection apparatus according to claim 1, wherein
the attribute of the road includes at least one item out of position information, a construction environment, a type of road surface, time elapsed since construction of the road, a traffic volume of a vehicle, and a past damage history.

5. The road surface inspection apparatus according to claim 4, wherein
the attribute of the road is position information of the road, and
the damage detection unit sets the target region, based on a rule for region setting previously tied to position information of the road.

6. The road surface inspection apparatus according to claim 1, wherein
the damage detection unit determines the attribute of the road, based on the image.

7. The road surface inspection apparatus according to claim 1, wherein
the damage detection unit switches processing logic used in the image processing, based on the attribute of the road.

8. The road surface inspection apparatus according to claim 7, wherein
the attribute of the road is a type of road surface of the road, and
the damage detection unit determines processing logic used in the image processing, based on the type of road surface.

9. The road surface inspection apparatus according to claim 1, wherein
the damage detection unit further identifies a type of damage to the road in the image processing, and
the information output unit further outputs information indicating the type of damage to the road detected by the image processing.

10. The road surface inspection apparatus according to claim 9, wherein
the information output unit computes a degree of damage for each identified type of damage to the road and further outputs information indicating the degree of damage computed for the each type of damage.

11. The road surface inspection apparatus according to claim 1, wherein
the position determination information includes at least one item out of latitude-longitude information of the road and a frame number of the image.

12. The road surface inspection apparatus according to claim 1, further comprising
a display processing unit that displays, on a display apparatus, a superimposed image acquired by superimposing, on the image, information indicating a position of damage to the road detected by the image processing.

13. A road surface inspection method comprising, by a computer:
acquiring an image in which a road is captured;
setting a target region in the image in image processing for detecting damage to a road, based on an attribute of the road captured in the image;
performing the image processing on the set target region; and
outputting position determination information allowing determination of a position of a road damage to which is detected by the image processing.

14. A non-transitory computer readable medium storing a program causing a computer to execute a road surface inspection method, the method comprising:
acquiring an image in which a road is captured;
setting a target region in the image in image processing for detecting damage to a road, based on an attribute of the road captured in the image;
performing the image processing on the set target region; and
outputting position determination information allowing determination of a position of a road damage to which is detected by the image processing.
